(19) United States
(12) Patent Application Publication
(10) Pub. No.: US 2024/0377783 A1
(43) Pub. Date: Nov. 14, 2024

(54) LOAD DRIVING DEVICE CAPABLE OF ACQUIRING POWER SUPPLY TEMPERATURE, IMAGE FORMING APPARATUS, AND TEMPERATURE ACQUISITION METHOD

(71) Applicant: KYOCERA Document Solutions Inc., Osaka (JP)

(72) Inventor: Kazunobu Iritani, Osaka (JP)

(21) Appl. No.: 18/659,281

(22) Filed: May 9, 2024

(30) Foreign Application Priority Data
May 11, 2023 (JP) 2023-078377

(51) Int. Cl. G03G 15/00; G03G 21/20

(52) U.S. Cl. CPC G03G 15/80; G03G 15/50; G03G 21/20

(57) ABSTRACT

A load driving device including a power supply, a first acquisition processing portion, a second acquisition processing portion, and a third acquisition processing portion. The power supply converts power supplied from a commercial power supply and outputs the converted power to a load. The first acquisition processing portion acquires an initial temperature of the power supply at a time of starting driving of the load, based on an environmental temperature of the load driving device. The second acquisition processing portion acquires a drive current flowing through the load. The third acquisition processing portion acquires a temperature of the power supply at time of acquisition based on the initial temperature acquired by the first acquisition processing portion, the drive current acquired by the second acquisition processing portion, and the drive time of the load from the start of driving the load to the time of acquisition.

### INCORPORATION BY REFERENCE

This application is based upon and claims the benefit of priority from the corresponding Japanese Patent Application No. 2023-078377 filed on May 11, 2023, the entire contents of which are incorporated herein by reference.

### BACKGROUND

The present disclosure relates to a load driving device, an Image forming apparatus, and a temperature acquisition method.

Image forming apparatuses such as printers include a power supply that supplies power to loads such as motors. In addition, an image forming apparatus that controls drive start timing of a fan that cools the power supply based on a detection result of a temperature of an electric component included in the power supply is known as related technology.

### SUMMARY

A load driving device according to an aspect of the present disclosure includes a power supply, a first acquisition processing portion, a second acquisition processing portion, and a third acquisition processing portion. The power supply converts power supplied from a commercial power supply and outputs the converted power to a load. The first acquisition processing portion acquires an initial temperature of the power supply at a time of starting driving of the load, based on an environmental temperature of the load driving device. The second acquisition processing portion acquires a drive current flowing through the load. The third acquisition processing portion acquires the temperature of the power supply at time of acquisition based on the initial temperature acquired by the first acquisition processing portion, the drive current acquired by the second acquisition processing portion, and the drive time of the load from the start of driving the load to the time of acquisition.

An image forming apparatus according to another aspect of the present disclosure includes an image forming portion and the load driving device. The image forming portion includes the load and forms an image on a sheet.

A temperature acquisition method according to another aspect of the present disclosure is executed by a load driving device that includes a power supply configured to convert power supplied by a commercial power supply and outputs the power to a load includes a first acquisition step, a second acquisition step, and a third acquisition step. In the first acquisition step, an initial temperature of the power supply at a time of starting driving of the load is acquired based on an environmental temperature of the load driving device. In the second acquisition step, a drive current flowing through the load is acquired. In the third acquisition step, a temperature of the power supply at time of acquisition is acquired based on the initial temperature acquired by the first acquisition step, the drive current acquired by the second acquisition step, and the drive time of the load from the time of starting driving of the load to the time of acquisition.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming apparatus of a first embodiment according to the present disclosure.

FIG. 2 is a block diagram showing a system configuration of an image forming apparatus of a first embodiment according to the present disclosure.

FIG. 3 is a diagram showing an example of a drive circuit in an image forming apparatus of a first embodiment according to the present disclosure.

FIG. 4 is a flowchart showing an example of a first drive control process executed by an image forming apparatus of a first embodiment according to the present disclosure.

FIG. 5 is a block diagram showing a system configuration of an image forming apparatus of a second embodiment according to the present disclosure.

FIG. 6 is a flowchart showing an example of a second drive control process executed by an image forming apparatus of a second embodiment according to the present disclosure.

### DETAILED DESCRIPTION

Hereinafter, embodiments according to the present disclosure will be described with reference to the drawings as appropriate. Note that the following embodiments are merely examples that embody a technique according to the present disclosure, and do not limit the technical scope of the present disclosure.

### First Embodiment

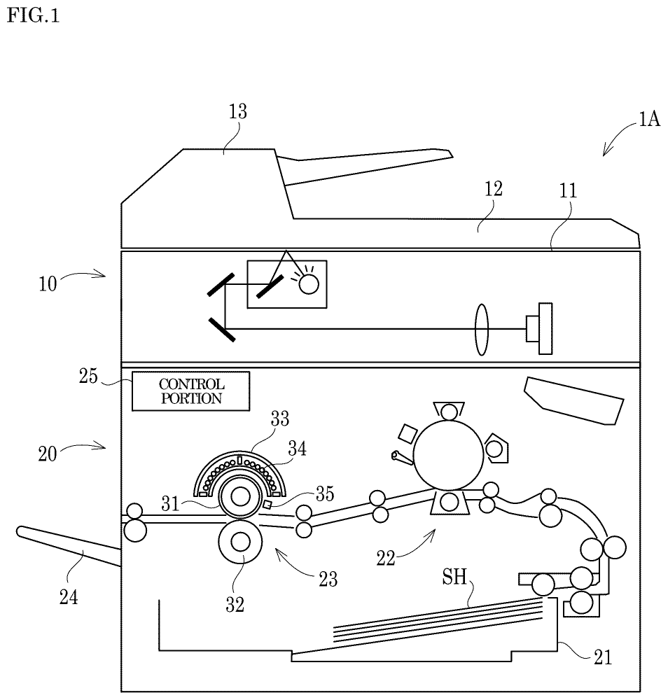

First, a configuration of an image forming apparatus 1A of a first embodiment according to the present disclosure will be described with reference to FIGS. 1 to 3.

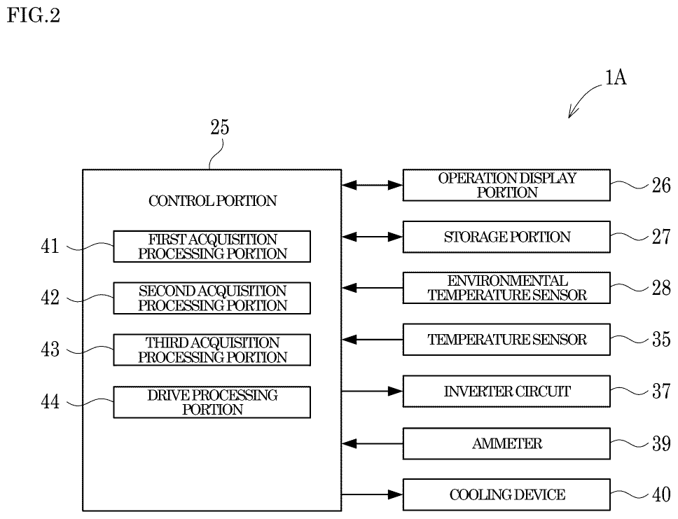

An image forming apparatus 1A shown in FIG. 1 is an image forming apparatus provided with various functions such as a printer, a copying machine, and a facsimile. This image forming apparatus 1A prints an image on a sheet SH based on input image data. The image forming apparatus 1A includes an image reading portion 10 that reads an image on a document, and an image forming portion 20 that forms an image on a sheet using electrophotography. In addition, the image forming apparatus 1A also includes a control portion 25, an operation display portion 26, a storage portion 27, and an environmental temperature sensor 28 shown in FIG. 2. Note that in the present embodiment, an image forming apparatus 1A will be described as an example of the image forming apparatus according to the present disclosure; however, the image forming apparatus according to present disclosure is not limited to this, and the image forming apparatus according to the present disclosure may also be applied to printers, facsimile machines, and copiers, for example.

The image reading portion 10 includes a contact glass 11 of a document mounting surface, and a document cover 12 that opens and closes with respect to the contact glass 11. In a case where the image forming apparatus 1A functions as a copying machine, a document is set on the contact glass 11 and the document cover 12 is closed. After that, when a copy start instruction is input from the operation display portion 26 (see FIG. 2), the image reading portion 10 starts a reading operation and reads the image data of the document. Note that the document cover 12 is provided with an Auto Document Feeder (ADF) 13 that automatically feeds a document to be read by the image reading portion 10.

The image forming unit 20 is an electrophotographic printer that executes an image forming process (printing process) based on image data read by the image reading portion 10 or image data input from an external information processing apparatus. The image forming portion 20 includes a sheet feed cassette 21, an image creating portion 22, a fixing portion 23, and a discharging portion 24, as shown in FIG. 1.

The sheets SH stored in the sheet feed cassette 21 are taken out one by one by a feeding mechanism including a feeding roller. The sheet SH is conveyed along a conveying path within the image forming portion 20, passes through the image creating portion 22 and the fixing portion 23, and is discharged to the discharging portion 24.

The image creating portion 22 includes an exposure device, a photoconductor drum, a charging device, a developing device, a transfer roller, a cleaning blade, and a static eliminator, and forms a toner image on the sheet SH passing through a nip between the photoconductor drum and the transfer roller.

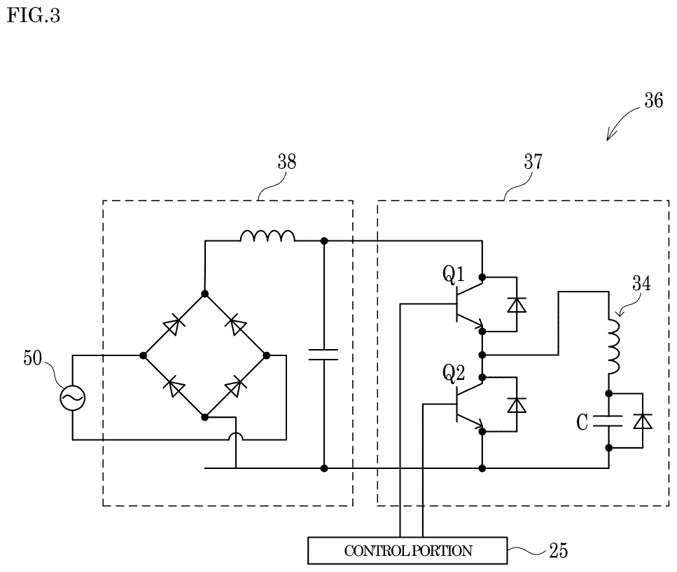

The fixing portion 23 fixes the toner image on the sheet SH. The fixing portion 23 includes a fixing roller 31, a pressure roller 32, an induction heater 33, and a temperature sensor 35 shown in FIG. 1. In addition, the fixing portion 23 includes a drive circuit 36 shown in FIG. 3. Moreover, the fixing portion 23 also includes an ammeter 39 and a cooling device 40 shown in FIG. 2.

The fixing roller 31 includes a roller portion and a belt portion. The roller portion includes, for example, a cylindrical core made of stainless steel or the like, and an elastic layer made of silicone resin or the like formed on the core. The belt portion is a cylindrical endless belt-like member provided along an outer peripheral surface of the roller portion. The belt portion includes a nickel metal film base material processed into a cylindrical shape, an elastic layer made of silicone resin or the like formed on the film base material, and a release layer made of fluororesin or the like that covers a surface of the elastic layer.

The pressure roller 32 is arranged at a position facing the fixing roller 31 and is in pressure contact with the fixing roller 31. The pressure roller 32 includes, for example, a cylindrical core made of stainless steel or the like, an elastic layer made of silicone resin or the like formed on the core, and a release layer made of fluororesin or the like that covers a surface of the elastic layer. The pressure roller 32 is rotated by a driving force from a drive motor (not shown). When the pressure roller 32 rotates, a driving force is transmitted from the pressure roller 32 to the fixing roller 31 through the nip portion between the pressure roller 32 and the fixing roller 31, and the fixing roller 31 also rotates.

The induction heater 33 heats the belt portion of the fixing roller 31 by induction heating. The induction heater 33 includes an induction coil 34 arranged in a vicinity of the belt portion along an outer peripheral surface of the fixing roller 31. A high-frequency current is applied to the induction coil 34 by an inverter circuit 37 (see FIG. 3), which will be described later. The induction coil 34 is excited by the applied high-frequency current, and inductively heats the belt portion of the fixing roller 31 by a magnetic flux generated by excitation.

When the sheet SH passes through the nip portion formed by the belt portion heated by the induction heater 33 and the pressure roller 32, the toner image is fixed on the sheet SH.

The temperature sensor 35 detects a surface temperature of the fixing roller 31. The temperature sensor 35 is, for example, a thermistor arranged near a surface of the fixing roller 31.

The drive circuit 36 converts power supplied from a commercial AC power supply 50 (see FIG. 3) (an example of a commercial power supply according to the present disclosure) and outputs the converted power to the induction heater 33 (an example of a load according to the present disclosure). The drive circuit 36 is an example of a power supply according to the present disclosure.

As shown in FIG. 3, the drive circuit 36 includes the inverter circuit 37 and a rectifier circuit 38.

As shown in FIG. 3, the inverter circuit 37 is, for example, a current resonance type inverter circuit having a switching element. The inverter circuit 37 is connected to an external commercial AC power supply 50 via the rectifier circuit 38. The rectifier circuit 38 converts the alternating current supplied from the commercial AC power supply 50 into direct current. The inverter circuit 37 converts the direct current supplied from the rectifier circuit 38 into a high-frequency current and supplies the high-frequency current to the induction coil 34.

In the inverter circuit 37, the induction coil 34 and a resonant capacitor C are connected in series, and the induction coil 34 and the resonant capacitor C constitute a resonant circuit. The inverter circuit 37 includes a pair of switching elements Q1, Q2, and the induction coil 34 and the resonant capacitor C are connected in parallel with the switching element Q2.

A drive signal from the control portion 25 is input to the gate terminals of the switching elements Q1, Q2. The drive signal is a signal for switching the switching elements Q1, Q2 between an ON state and an OFF state at a predetermined drive frequency. By controlling switching of the switching elements Q1, Q2 according to the drive signal, a high-frequency current according to the drive frequency is applied to the induction coil 34. The driving frequency is determined based on the output result of the temperature sensor 35 and the like.

The ammeter 39 measures the drive current flowing through the induction coil 34 of the induction heater 33. The measurement result of the drive current by the ammeter 39 is used to detect an abnormal state in which the current flowing through the induction coil 34 exceeds a predetermined allowable limit.

The cooling device 40 cools the drive circuit 36. More specifically, the cooling device 40 is a cooling fan that air-cools the drive circuit 36. Note that the cooling device 40 may be a water cooling device that cools the drive circuit 36 with water.

The operation display portion 26 includes a display portion such as a liquid-crystal display that displays information, and an operation portion such as a touch panel and operation buttons that accept user operations.

The storage portion 27 is a non-volatile storage device such as a flash memory. The storage portion 27 stores various types of control programs executed by the control portion 25 and various types of data.

The environmental temperature sensor 28 detects an environmental temperature of the image forming apparatus 1A. The environmental temperature sensor 28 is a sensor that can detect temperature (air temperature) at an installation location. The environmental temperature sensor 28 is provided inside a housing of the image forming apparatus 1A. In addition, the environmental temperature sensor 28 may also be provided outside the housing of the image forming apparatus 1A. The detection result of the environmental temperature by the environmental temperature sensor 28 is used for adjusting the image forming conditions by the image forming portion 20, or the like.

The control portion 25 includes control devices such as a CPU, ROM, and RAM. The CPU is a processor that executes various types of arithmetic processing. The ROM is a non-volatile storage device in which information such as a control program for causing the CPU to execute various types of processes is stored in advance. The RAM is a volatile or non-volatile storage device used as a temporary storage memory (work area) for various types of processes executed by the CPU.

An image forming apparatus that controls the drive start timing of the cooling device 40 based on the detection results of the temperatures of electrical components such as switching elements and diodes included in the drive circuit 36 is known as related technology.

However, in the image forming apparatus according to the above-mentioned related technology, it is necessary to provide a dedicated sensor for detecting the temperature of the electrical components.

On the other hand, in the image forming apparatus 1A of the first embodiment according to the present disclosure, as will be described below, the temperature of the drive circuit 36 can be acquired without providing a dedicated sensor.

More specifically, the control portion 25 includes a first acquisition processing portion 41, a second acquisition processing portion 42, a third acquisition processing portion 43, and a drive processing portion 44 shown in FIG. 2. Note that the control portion 25 functions as each processing portion by executing various types of processes according to the control program. In addition, the control portion 25 may include an electronic circuit that achieves some or a plurality of processing functions of each processing portion. A combination of the drive circuit 36, the cooling device 40, and the control portion 25 is an example of the load driving device according to the present disclosure.

The first acquisition processing portion 41, based on the environmental temperature of the image forming apparatus 1A, acquires the initial temperature of the drive circuit 36 at the time when the induction heater 33 starts driving.

For example, the first acquisition processing portion 41 acquires the initial temperature based on the temperature of the drive circuit 36 at the time when the immediately preceding driving of the induction heater 33 ends, the elapsed time from the end of driving to the start of the next driving of the induction heater 33, and the environmental temperature at the start of that driving. For example, the first acquisition processing portion 41 calculates an amount of decrease in temperature of the drive circuit 36 since the end of the driving by multiplying the elapsed time since the end of the immediately preceding driving of the induction heater 33 with a coefficient based on the temperature difference between the temperature of the drive circuit 36 at the end of the immediately preceding driving of the induction heater 33 and the environmental temperature. The first acquisition processing portion 41 acquires the initial temperature by subtracting the calculated temperature decrease amount from the temperature of the drive circuit 36 at the end of the immediately preceding driving of the induction heater 33. Note that the temperature of the drive circuit 36 at the end of the immediately preceding driving of the induction heater 33 is acquired by the third acquisition processing portion 43. In addition, the elapsed time since the end of the immediately preceding driving of the induction heater 33 is measured or calculated by the control portion 25. Moreover, the environmental temperature is acquired using the environmental temperature sensor 28.

Note that the first acquisition processing portion 41 may acquire the environmental temperature of the image forming apparatus 1A as the initial temperature.

The second acquisition processing portion 42 acquires the drive current flowing through the induction heater 33.

For example, the second acquisition processing portion 42 uses the ammeter 39 to acquire the drive current.

The third acquisition processing portion 43 acquires the temperature of the drive circuit 36 at the time of acquisition based on the initial temperature acquired by the first acquisition processing portion 41, the drive current acquired by the second acquisition processing portion 42, and the drive time of the induction heater 33 from the start of driving the induction heater 33 to the time of acquisition.

For example, in a case where a first temperature acquired based on the initial temperature, the drive current and the drive time is equal to or less than a second temperature acquired based on the initial temperature and the drive current, the third acquisition processing portion 43 acquires the first temperature as the temperature of the drive circuit 36 at the time of acquisition. In addition, in a case where the first temperature exceeds the second temperature, the third acquisition processing portion 43 acquires the second temperature as the temperature of the drive circuit 36 at the time of acquisition.

Here, the first temperature is calculated according to the following Equation (1). Note that in Equation (1), X1 represents the first temperature. In addition, in Equation (1), I represents the drive current. Moreover, in Equation (1), T represents the drive time. Furthermore, in Equation (1), A1 represents a predetermined first coefficient. For example, the first coefficient is set based on the heat generation characteristic of the electric component among the electric components included in the drive circuit 36 that generates the largest amount of heat generated by driving the induction heater 33. In addition, in Equation (1), X0 represents the initial temperature.

$$X 1 = ( I \times T ) \div A 1 + X 0 \qquad ( 1 )$$

In addition, the second temperature is calculated according to the following Equation (2). Note that in Equation (2), X2 represents the second temperature. Furthermore, in Equation (2), A2 represents a predetermined second coefficient. For example, the second coefficient is set based on the heat generation characteristic of the electric component among the electric components included in the drive circuit 36 that generates the largest amount of heat generated by driving the induction heater 33.

$$X 2 = ( I + X 0 ) \times A 2 \qquad ( 2 )$$

When the induction heater 33 starts to be driven, the temperature of the drive circuit 36 increases over time. After a certain amount of time has elapsed since the start of driving the induction heater 33, the temperature of the drive circuit 36 converges to a constant temperature.

Here, the temperature of the drive circuit 36 during the temperature increase period in which the temperature of the drive circuit 36 increases depends on the initial temperature, the drive current, and the drive time. That is, it is possible to estimate the temperature of the drive circuit 36 during the temperature increase period based on the initial temperature, the drive current, and the drive time. The above Equation (1) is an example of means for estimating the temperature of the drive circuit 36 during the temperature increase period based on the initial temperature, the drive current, and the drive time.

In addition, the temperature of the drive circuit 36 during the temperature convergence period during which the temperature of the drive circuit 36 converges depends on the initial temperature and the drive current. That is, it is possible to estimate the temperature of the drive circuit 36 during the temperature convergence period based on the initial temperature and the drive current. The above Equation (2) is an example of means for estimating the temperature of the drive circuit 36 during the temperature convergence period based on the initial temperature and the drive current.

For example, the third acquisition processing portion 43 acquires the current temperature of the drive circuit 36 at a predetermined acquisition cycle from the start of driving the induction heater 33. For example, the acquisition cycle is a cycle that is arbitrarily set within the range of 0.1 seconds to 10 seconds.

In addition, in a case where the driving of the induction heater 33 ends, the third acquisition processing portion 43 acquires the temperature of the drive circuit 36 at the time when the driving of the induction heater 33 ends.

The drive processing portion 44 drives the cooling device 40 in a case where the current temperature of the drive circuit 36 acquired by the third acquisition processing portion 43 exceeds a predetermined allowable temperature. For example, the allowable temperature is set based on the upper limit temperature in a temperature range in which the drive circuit 36 can operate normally.

### [First Drive Control Process]

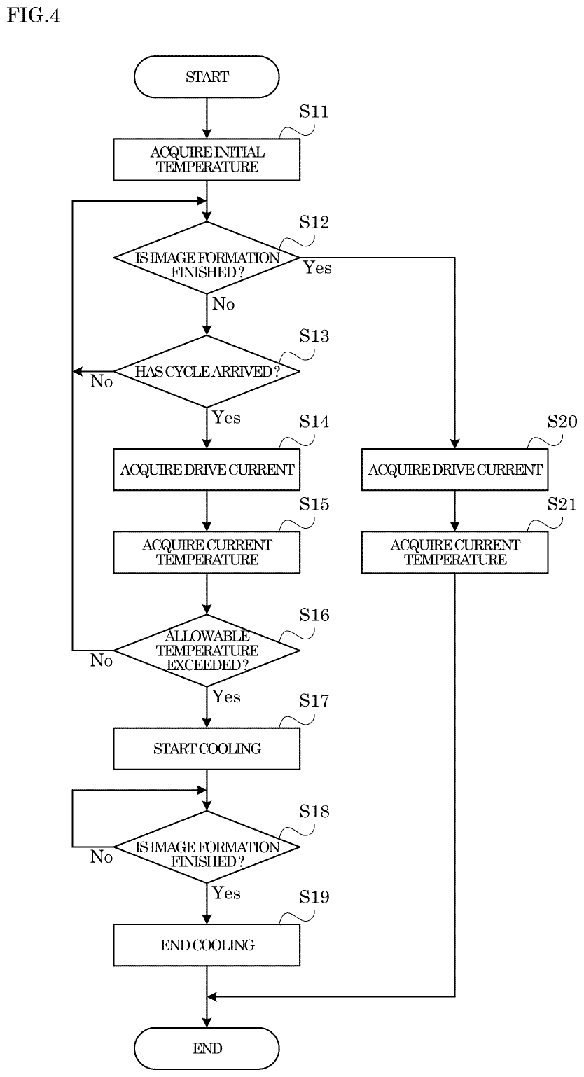

Hereinafter, with reference to FIG. 4, a temperature acquisition method according to the present disclosure will be described along with an example of a procedure of the first drive control process executed by the control portion 25 in the image forming apparatus 1A. Here, steps S11, S12, and so on represent the numbers of processing procedures (steps) executed by the control portion 25. Note that the first drive control process is executed when the induction heater 33 starts to be driven at the start of execution of the image forming process.

### <Step S11>

First, in step S11, the control portion 25 acquires the initial temperature. Here, the process of step S11 is an example of a first acquisition step according to the present disclosure, and is executed by the first acquisition processing portion 41 of the control portion 25.

### <Step S12>

In step S12, the control portion 25 determines whether the image forming process is finished.

Here, when the control portion 25 determines that the image forming process is finished (YES in S12), the control portion 25 moves the process to step S20. In addition, when the image forming process is not finished (NO in S12), the control portion 25 moves the process to step S13.

### <Step S13>

In step S13, the control portion 25 determines whether the acquisition cycle has arrived.

Here, when the control portion 25 determines that the acquisition cycle has arrived (YES in S13), the control portion 25 moves the process to step S14. Moreover, when the acquisition cycle has not arrived (NO in S13), the control portion 25 moves the process to step S12.

### <Step S14>

In step S14, the control portion 25 acquires the drive current. Here, the process of step S14 is an example of a second acquisition step according to the present disclosure, and is executed by the second acquisition processing portion 42 of the control portion 25.

### <Step S15>

In step S15, the control portion 25 acquires the current temperature of the drive circuit 36 based on the initial temperature acquired by the process of step S11, the drive current acquired by the process of step S14, and the drive time from the start of driving the induction heater 33 to the current time. Here, the process of step S15 is an example of a third acquisition step according to the present disclosure, and is executed by the third acquisition processing portion 43 of the control portion 25.

More specifically, the control portion 25 calculates the first temperature using the above Equation (1). In addition, the control portion 25 calculates the second temperature using the above Equation (2). The control portion 25 acquires the first temperature as the current temperature of the drive circuit 36 in a case where the first temperature is equal to or lower than the second temperature, and acquires the second temperature as the current temperature of the drive circuit 36 in a case where the first temperature exceeds the second temperature.

### <Step S16>

In step S16, the control portion 25 determines whether the current temperature of the drive circuit 36 acquired in the process of step S15 exceeds the allowable temperature.

Here, when the control portion 25 determines that the current temperature of the drive circuit 36 exceeds the allowable temperature (YES in S16), the control portion 25 moves the process to step S17. In addition, when the current temperature of the drive circuit 36 does not exceed the allowable temperature (NO in S16), the control portion 25 moves the process to step S12.

### <Step S17>

In step S17, the control portion 25 starts driving the cooling device 40. Here, the process of step S17 is executed by the drive processing portion 44 of the control portion 25.

### <Step S18>

In step S18, the control portion 25 determines whether the image forming process is finished.

Here, when the control portion 25 determines that the image forming process is finished (YES in S18), the control portion 25 moves the process to step S19. In addition, when the image forming process is not finished (NO in S18), the control portion 25 waits for the image forming process to end in step S18.

### <Step S19>

In step S19, the control portion 25 ends the driving of the cooling device 40.

Note that the control portion 25 may end the driving of the cooling device 40 in a case where the drive current decreases beyond a predetermined current value before the image forming process ends.

### <Step S20>

In step S20, the control portion 25 acquires the drive current, similar to the process in step S14. Here, the process of step S20 is executed by the second acquisition processing portion 42 of the control portion 25.

### <Step S21>

In step S21, the control portion 25 acquires the current temperature of the drive circuit 36 based on the initial temperature acquired by the process of step S11, the drive current acquired by the process of step S20, and the drive time from the start of driving the induction heater 33 to the current time. Here, the process of step S21 is executed by the third acquisition processing portion 43 of the control portion 25.

Here, in step S11 that is executed first after the process of step S21, the control portion 25 acquires the initial temperature based on the temperature of the drive circuit 36 acquired in the process of step S21, the elapsed time from the execution of the process of step S21, and the environmental temperature. More specifically, the control portion 25, by multiplying the elapsed time since the execution of the immediately preceding step S21 by a coefficient based on the temperature difference between the temperature of the drive circuit 36 acquired in the immediately preceding step S21 and the environmental temperature, calculates the amount of temperature decrease of the drive circuit 36 from the time of execution. The control portion 25 acquires the initial temperature by subtracting the calculated temperature decrease amount from the temperature of the drive circuit 36 acquired in the process of the immediately preceding step S21.

On the other hand, in step S11 that is executed first after the process of step S19, the control portion 25 acquires the environmental temperature as the initial temperature. This is because the driving circuit 36 is sufficiently cooled by the driving of the cooling device 40.

In this way, in the image forming apparatus 1A, the current temperature of the drive circuit 36 is acquired based on the initial temperature acquired using the environmental temperature sensor 28 which is also used for other purposes, the drive current acquired using the ammeter 39 which is also used for other purposes, and the drive time of the induction heater 33 from the start of driving the induction heater 33 to the present time; Therefore, the temperature of the drive circuit 36 can be acquired without providing a dedicated sensor.

### Second Embodiment

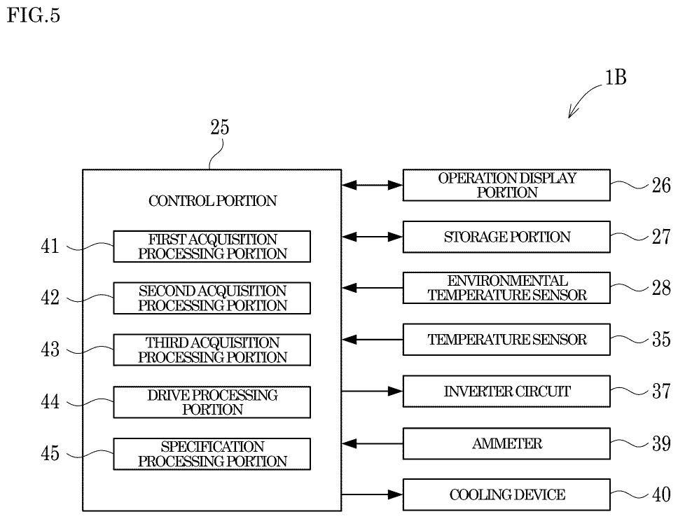

Hereinafter, the configuration of an image forming apparatus 1B of a second embodiment according to the present disclosure will be described with reference to FIG. 5.

An image forming apparatus 1B shown in FIG. 5 differs from the image forming apparatus 1A in the configuration of the control portion 25. Note that the other aspects are common between the image forming apparatus 1A and the image forming apparatus 1B. Hereinafter, only the parts of the configuration of the image forming apparatus 1B that are different from the image forming apparatus 1A will be described.

As shown in FIG. 5, the control portion 25 of the image forming apparatus 1B includes a first acquisition processing portion 41, a second acquisition processing portion 42, a third acquisition processing portion 43, a drive processing portion 44, and a specification processing portion 45.

The functions of the first acquisition processing portion 41 and the second acquisition processing portion 42 are the same as those of the first acquisition processing portion 41 and the second acquisition processing portion 42 of the image forming apparatus 1A.

When the driving of the induction heater 33 is started, the third acquisition processing portion 43 acquires in advance the temperature of the drive circuit 36 at each point in time when the elapsed time from the start of driving the induction heater 33 reaches a multiple of a predetermined reference time. For example, the reference time is a time that is arbitrarily set within the range of 0.1 seconds to 10 seconds. Thus, it becomes possible to predict the temperature transition of the drive circuit 36 from the start of driving the induction heater 33.

The specification processing portion 45, based on the acquisition result by the third acquisition processing portion 43, specifies the drive start timing at which the temperature of the drive circuit 36 exceeds the allowable temperature.

The drive processing portion 44 drives the cooling device 40 in a case where the drive start timing specified by the specification processing portion 45 arrives while the induction heater 33 is being driven.

### [Second Drive Control Process]

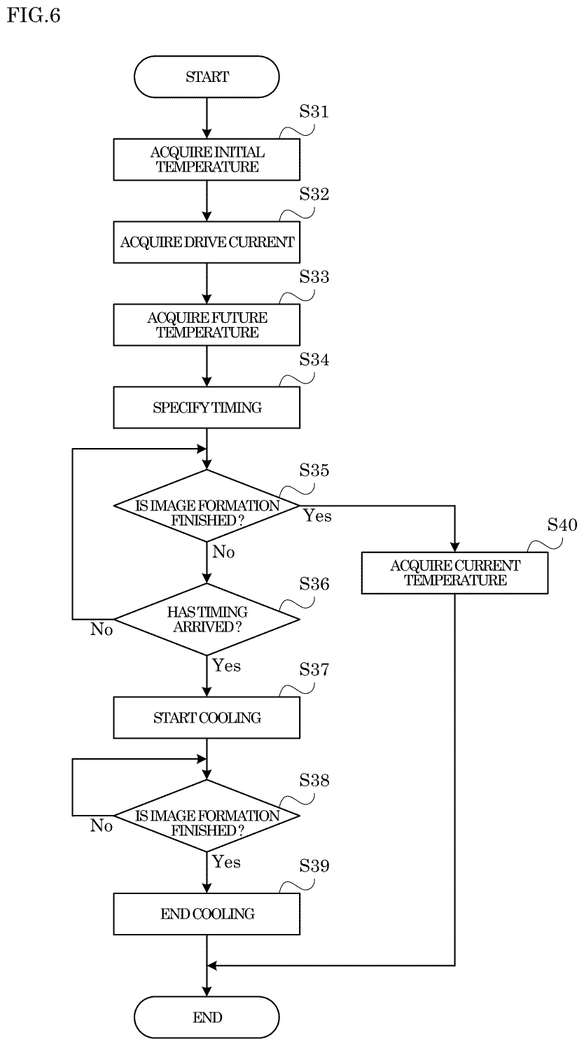

Hereinafter, an example of the procedure of the second drive control process executed by the control portion 25 in the image forming apparatus 1B will be described with reference to FIG. 6. Note that the second drive control process is executed when the induction heater 33 starts to be driven at the start of execution of the image forming process.

### <Step S31>

First, in step S31, the control portion 25 acquires the initial temperature. Here, the process of step S31 is executed by the first acquisition processing portion 41 of the control portion 25.

### <Step S32>

In step S32, the control portion 25 acquires the drive current. Here, the process of step S32 is executed by the second acquisition processing portion 42 of the control portion 25.

### <Step S33>

In step S33, the control portion 25 acquires in advance the temperature of the drive circuit 36 at each point in time when the elapsed time from the start of driving the induction heater 33 reaches a multiple of the reference time. Here, the process of step S33 is executed by the third acquisition processing portion 43 of the control portion 25.

More specifically, every time the elapsed time from the start of driving the induction heater 33 reaches a multiple of the reference time, the control portion 25 acquires the temperature of the drive circuit 36 at that point in time based on the initial temperature acquired by the process of step S31, the drive current acquired by the process of step S32, and the drive time from the start of driving the induction heater 33 to that point in time.

### <Step S34>

In step S34, the control portion 25 specifies the drive start timing at which the temperature of the drive circuit 36 exceeds the allowable temperature, based on the acquired result of the process in step S33. Here, the process of step S34 is executed by the specification processing portion 45 of the control portion 25.

### <Step S35>

In step S35, the control portion 25 determines whether the image forming process is finished.

Here, when the control portion 25 determines that the image forming process is finished (YES in S35), the control portion 25 moves the process to step S40. In addition, when the image forming process is not finished (NO in S35), the control portion 25 moves the process to step S36.

### <Step S36>

In step S36, the control portion 25 determines whether the drive start timing specified by the process in step S34 has arrived.

Here, when the control portion 25 determines that the drive start timing has arrived (YES in S36), the control portion 25 moves the process to step S37. In addition, when the drive start timing has not arrived (NO in S36), the control portion 25 moves the process to step S35.

### <Step S37>

In step S37, the control portion 25 starts driving the cooling device 40. Here, the process of step S37 is executed by the drive processing portion 44 of the control portion 25.

<Step S38>

In step S38, the control portion 25 determines whether the image forming process is finished.

Here, when the control portion 25 determines that the image forming process is finished (YES in S38), the control portion 25 moves the process to step S39. In addition, when the image forming process is not finished (NO in S38), the control portion 25 waits for the image forming process to end in step S38.

### <Step S39>

In step S39, the control portion 25 ends the driving of the cooling device 40.

Note that the control portion 25 may end the driving of the cooling device 40 in a case where the drive current decreases beyond a predetermined current value before the image forming process ends.

### <Step S40>

In step S40, the control portion 25 acquires the current temperature of the drive circuit 36 based on the initial temperature acquired by the process of step S31, the drive current acquired by the process of step S32, and the drive time from the start of driving the induction heater 33 to the current time. Here, the process of step S40 is executed by the third acquisition processing portion 43 of the control portion 25.

Here, in step S31 that is executed first after the process of step S40, the control portion 25 acquires the initial temperature based on the temperature of the drive circuit 36 acquired in the process of step S40, the elapsed time from the execution of the process of step S40, and the environmental temperature.

On the other hand, in step S31 that is executed first after the process of step S39, the control portion 25 acquires the environmental temperature as the initial temperature.

In this way, in the image forming apparatus 1B as well, the temperature of the drive circuit 36 can be acquired without providing a dedicated sensor, similarly to the image forming apparatus 1A.

Note that the load according to the present disclosure is not limited to the induction heater 33, and may be a motor or the like. In addition, the power supply according to the present disclosure is not limited to the drive circuit 36, and may be an AC-DC converter, a DC-DC converter, or the like. Moreover, the load driving device according to the present disclosure may be provided in an electrical device different from the image forming apparatus.

### Disclosure Notes

In the following, a summary of the disclosure extracted from the above-described embodiments will be added. Note that each configuration and each processing function described in the following supplementary notes may be selected and combined as desired.

### Supplementary Note 1

A load driving device including:
a power supply configured to convert power supplied from a commercial power supply and output the power to a load;
a first acquisition processing portion configured to acquire an initial temperature of the power supply at a time of starting driving of the load based on an environmental temperature of the load driving device;
a second acquisition processing portion configured to acquire a drive current flowing through the load; and
a third acquisition processing portion configured to acquire a temperature of the power supply at time of acquisition based on the initial temperature acquired by the first acquisition processing portion, the drive current acquired by the second acquisition processing portion, and the drive time of the load from the start of driving the load to the time of acquisition.

### Supplementary Note 2

The load driving device according to Supplementary Note 1, wherein
the third acquisition processing portion, in a case where a first temperature acquired based on the initial temperature, the drive current, and the drive time is equal to or less than a second temperature acquired based on the initial temperature and the drive current, acquires the first temperature as the temperature of the power supply at the time of acquisition, and in a case where the first temperature is greater than the second temperature, acquires the second temperature as the temperature of the power supply at the time of acquisition.

### Supplementary Note 3

The load driving device according to Supplementary Note 2, wherein
when driving of the load ends, the third acquisition processing portion acquires the temperature of the power supply at the time when driving of the load ends; and
the first acquisition processing portion acquires the initial temperature based on the temperature of the power supply at the time when driving of the immediately preceding load ended, the elapsed time from when the driving ended, and the environmental temperature.

### Supplementary Note 4

The load driving device according to any one of Supplementary Notes 1 to 3, wherein
the third acquisition processing portion acquires a current temperature of the power supply at a predetermined acquisition cycle from the start of driving the load; and
the load driving device further includes:
a cooling portion configured to cool the power supply; and
a drive processing portion configured to drive the cooling portion in a case where the current temperature of the power supply acquired by the third acquisition processing portion exceeds a predetermined allowable temperature.

### Supplementary Note 5

The load driving device according to any one of Supplementary Notes 1 to 3, wherein
in a case where driving the load is started, the third acquisition processing portion acquires the temperature of the power supply at each point in time when the elapsed time from the start of driving the load reaches a multiple of a predetermined reference time; and
the load driving device further includes:
a cooling portion configured to cool the power supply;
a specification processing portion configured to specify a drive start timing at which the temperature of the power supply exceeds a predetermined allowable temperature based on the acquisition result by the third acquisition processing portion; and
a drive processing portion configured to drive the cooling portion when the drive start timing specified by the specification processing portion arrives while the load is being driven.

### Supplementary Note 6

An image forming apparatus, including:
an image forming portion that includes the load and configured to form an image on a sheet; and
the load driving device according any one of Supplementary Notes 1 to 5.

### Supplementary Note 7

A temperature acquisition method executed by a load driving device provided with a power supply configured to convert power supplied from a commercial power supply and output the power to a load, the method including:
a first acquisition step of acquiring an initial temperature of the power supply at a time of starting driving of the load based on an environmental temperature of the load driving device;
a second acquisition step of acquiring a drive current flowing through the load; and
a third acquisition step of acquiring a temperature of the power supply at time of acquisition based on the initial temperature acquired by the first acquisition step, the drive current acquired by the second acquisition step, and the drive time of the load from the start of driving the load to the time of acquisition.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A load driving device, comprising:
a power supply configured to convert power supplied from a commercial power supply and output the power to a load;
a first acquisition processing portion configured to acquire an initial temperature of the power supply at a time of starting driving of the load based on an environmental temperature of the load driving device;
a second acquisition processing portion configured to acquire a drive current flowing through the load; and
a third acquisition processing portion configured to acquire a temperature of the power supply at time of acquisition based on the initial temperature acquired by the first acquisition processing portion, the drive current acquired by the second acquisition processing portion, and the drive time of the load from the start of driving the load to the time of acquisition.

2. The load driving device, according to claim 1, wherein
the third acquisition processing portion, in a case where a first temperature acquired based on the initial temperature, the drive current, and the drive time is equal to or less than a second temperature acquired based on the initial temperature and the drive current, acquires the first temperature as the temperature of the power supply at the time of acquisition, and in a case where the first temperature is greater than the second temperature, acquires the second temperature as the temperature of the power supply at the time of acquisition.

3. The load driving device, according to claim 2, wherein
when driving of the load ends, the third acquisition processing portion acquires the temperature of the power supply at the time when driving of the load ends; and
the first acquisition processing portion acquires the initial temperature based on the temperature of the power supply at the time when driving of the immediately preceding load ended, the elapsed time from when the driving ended, and the environmental temperature.

4. The load driving device, according to claim 2, wherein
the third acquisition processing portion acquires a current temperature of the power supply at a predetermined acquisition cycle from the start of driving the load; and
the load driving device further includes:
a cooling portion configured to cool the power supply; and
a drive processing portion configured to drive the cooling portion in a case where the current temperature of the power supply acquired by the third acquisition processing portion exceeds a predetermined allowable temperature.

5. The load driving device, according to claim 2, wherein
in a case where driving the load is started, the third acquisition processing portion acquires the temperature of the power supply at each point in time when the elapsed time from the start of driving the load reaches a multiple of a predetermined reference time; and
the load driving device further includes:
a cooling portion configured to cool the power supply;
a specification processing portion configured to specify a drive start timing at which the temperature of the power supply exceeds a predetermined allowable temperature based on the acquisition result by the third acquisition processing portion; and
a drive processing portion configured to drive the cooling portion when the drive start timing specified by the specification processing portion arrives while the load is being driven.

6. An image forming apparatus, comprising:
an image forming portion that includes the load and configured to form an image on a sheet; and
the load driving device according to claim 1.

7. A temperature acquisition method executed by a load driving device provided with a power supply that converts power supplied from a commercial power supply and outputs the power to a load, the method comprising:
a first acquisition step of acquiring an initial temperature of the power supply at a time of starting driving of the load based on an environmental temperature of the load driving device;
a second acquisition step of acquiring a drive current flowing through the load; and
a third acquisition step of acquiring a temperature of the power supply at time of acquisition based on the initial temperature acquired by the first acquisition step, the drive current acquired by the second acquisition step, and the drive time of the load from the start of driving the load to the time of acquisition.
